(19) United States
(12) Patent Application Publication
(10) Pub. No.: US 2017/0091392 A1
(43) Pub. Date: Mar. 30, 2017

(54) BIOMETRIC IDENTIFICATION TELEMEDICINE SOFTWARE

(71) Applicants: Steven C. White, Santa Monica, CA (US); Charles V. Evans, JR., Santa Monica, CA (US)

(72) Inventors: Steven C. White, Santa Monica, CA (US); Charles V. Evans, JR., Santa Monica, CA (US)

(21) Appl. No.: 15/144,764

(22) Filed: May 2, 2016

Related U.S. Application Data
(60) Provisional application No. 62/156,140, filed on May 1, 2015.

(51) Int. Cl. G06F 19/00; G06F 21/32; G06F 21/60; G06F 21/62

(52) U.S. Cl. CPC G06F 19/322; G06F 19/3418; G06F 21/6245; G06F 21/32; G06F 21/602

(57) ABSTRACT

A method and system for secure electronic transfer of patient information is described, along with submethods and subsystems for encoding the patient information and for accessing the patient information. The patient biometric identification information is used to create a distinct encrypted biometric identity. Access to a patient's information is conditioned on a match to the patient biometric identification.

### CROSS-REFERENCE TO RELATED APPLICATION(S)

This application claims the benefit and the priority of U.S. Provisional Patent Application No. 62/156,140 filed May 1, 2015, the entire content of which is incorporated herein by reference.

### BACKGROUND OF THE INVENTION

This invention relates to the field of telemedicine; biometric identification may or may not be coupled with non-invasive blood analyte detection methods. The invention comprises a validation system using biometric identification which may or may not include microchip (RFID) implants to access, review, or change electronic patient health information.

### SUMMARY OF THE INVENTION

The present invention involves biometric identification telemedicine software, or B.I.T.S and a system for using such software.

The B.I.T.S system works by using a biometric scanner to identify the physiological unique features e.g. fingertip, retinal scan, facial recognition, RFID microchip, for identification and verification purposes.

The B.I.T.S system may or may not include a patient ID Tag (e.g. date of birth, social security number, or personal pin) coupled with biometric ID encoder/decoder for verification or authentication of patient.

The B.I.T.S may or may not include: encoder plus biometric ID plus tag ID; decoder plus tag ID; or decoder plus biometric ID plus tag ID.

Patient information is not transferred, only the biometric identity which is encrypted and directly linked to one specific patient file. This identity is linked to one patient medical record and one identity upon software registration.

Electronic patient health information and/or biometric identity and/or patient ID tags may or may not be stored in a secured cloud based storage system or on secure servers.

The B.I.T.S system may be used at point of sale (POS) systems for identity verification and validation for pharmaceutical medicine purchases or electronic patient health information data entry and amendment.

The B.I.T.S system may or may not require a patient ID for coupled ID verification e.g. date of birth or social security number or user pin.

The B.I.T.S system may or may not be used with RFID microchips to encrypt information with the encoder/decoder, and process information with the decoder.

The B.I.T.S system may be used within pharmacy networks to verify patient identification for prescription accuracy, authorized pick-up and tracking of pharmaceutical drugs as prescribed by physicians. This may or may not be coupled with an identification verification such as date of birth, social security number, or user pin.

The B.I.T.S system may include more than one biometric identification authorization; allowing patients or authorized individuals of this patient to access prescription medication. This system will help prevent insurance fraud, drug abuse and illegal prescription abuse of Schedule (II, Ill, IV, or V) prescription drugs.

The B.I.T.S system will target an internationally secured database allowing patients access to prescription refills while traveling abroad. International access to ePHI will help physicians and pharmacists identify any potential adverse medical reactions, verify current prescriptions, and offer authorized prescriptions globally.

The biometric identification telemedicine software (B.I.T.S) platform presents a method by which electronic patient health information is managed. The software platform in various embodiments will comply with the Title II Health Insurance Portability and Accountability Act of 1996 (HIPAA); meeting both the Privacy Rule and Security Rule. The Privacy Rule protects the privacy of personal health information, and sets limits and conditions on the uses and disclosures that may be made of such information without patient authorization. The Privacy Rule gives patients authority over their health information, including rights to examine and obtain a copy of their health records, and to request corrections. The B.I.T.S grants patient's authorization through sending only their biometric scans. The biometric scan may include fingerprint scan, hand scan, retina eye scan, facial recognition, RFID microchip, or any unique physiological characteristic (e.g. fingerprint, retina scan, facial recognition, RFID microchip). Patient biometric ID is scanned with the encoder, and encrypted. The caregivers or healthcare professional on the receiving-end will have the decoder to process said encrypted biometric identification. Access is then granted to the electronic patient health information file associated with this biometric identity.

The HIPAA Security Rule establishes national standards to protect individuals' electronic personal health information that is created, received, used, or maintained by a covered entity. The Security Rule requires appropriate administrative, physical and technical safeguards to ensure the confidentiality, integrity, and security of electronic protected health information. The B.I.T.S system ensures the aforementioned safeguards are met by only sending an encrypted biometric identity scan file. The biometric identity is not an actual patient file, only an encrypted identification (e.g. fingerprint, retina scan, facial recognition, or RFID microchip) that requires the encoder & decoder. Access to the patient file is only authorized with proper authorization from the encoder to encrypted information, and the decoder to process the encrypted information. The biometric identification decoder reads the biometric identity.

The B.I.T.S platform also meets the US-EU Safe Harbor compliance by maintaining the privacy and security of electronic patient health information across both US and EU markets. As improvements in healthcare shift towards health care quality, safety, and efficiency through secure health IT and information exchange, the B.I.T.S platform in various embodiments meets the Health Information Technology for Economic and Clinical Health (HITECH) standards through implementation of a secure telemedicine platform. The B.I.T.S platform may or may not be coupled with microchip implants. Using short-range radio frequency identification (RFID) signals, the microchip implant can transmit your identity as you pass through a security checkpoints, POS terminal, or check-in kiosk at the hospital. As healthcare moves into the non-invasive space and is now exploring microchip implants, the B.I.T.S biometric identification platform may also apply to scanning inserted microchips for identification and verification.

### BRIEF DESCRIPTION OF DRAWINGS:

FIG. 1 is a schematic diagram of one embodiment of the invention.

FIG. 2 is a schematic diagram of an aspect of one embodiment of the invention.

FIG. 3 is a schematic diagram of an application of one embodiment of the invention.

FIG. 4 is a schematic diagram of another aspect of one embodiment of the invention.

### DETAILED DESCRIPTION

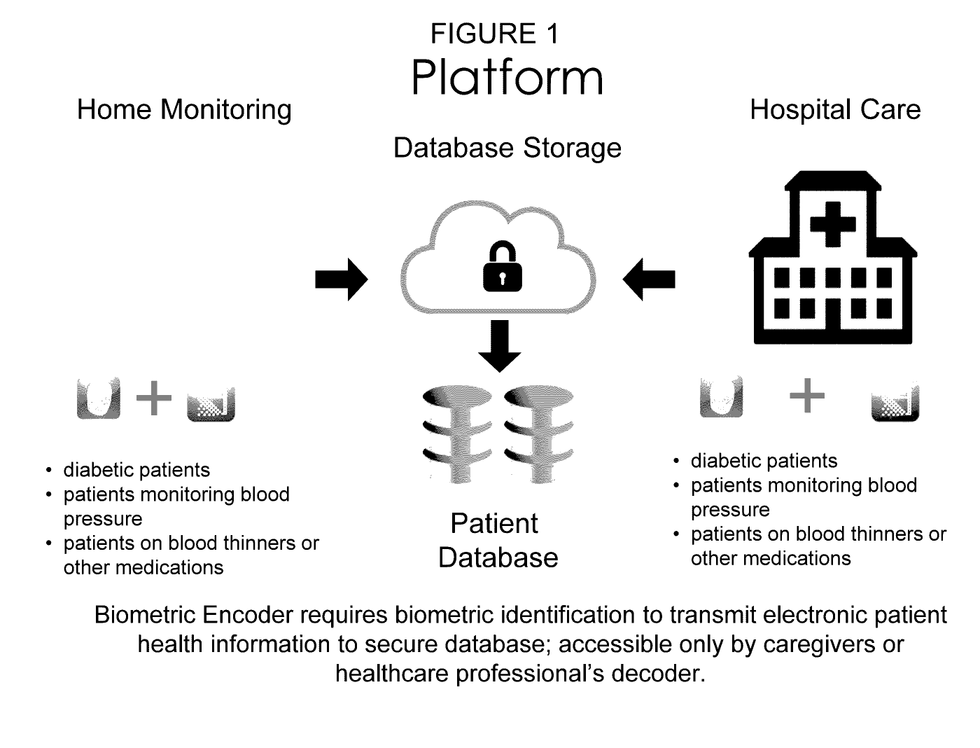

FIG. 1. illustrates the biometric identification telemedicine platform of one embodiment of the invention. The B.I.T.S security platform in two real-life scenarios; both home monitoring and hospital care in which patient information gathered on non-invasive medical devices can be stored in the cloud-based or secure server(s)database. In both home monitoring and hospital care, electronic health information includes, but is not limited to, data gathered from non-invasive blood analyte detection devices. This application is related to U.S. Provisional Patent Application No. 62/115,606 filed Feb. 12, 2015, and U.S. Provisional Patent Application No. 62/133,223 filed Mar. 13, 2015, the entire contents of which are incorporated herein by reference. The platform supports all forms of electronic patient health information, which is secured using the biometric identification platform. The data may include, blood glucose levels, blood oxygenation levels, blood cancer biomarker screening data, blood alcohol levels, medical prescriptions, or form of electronic patient health information.

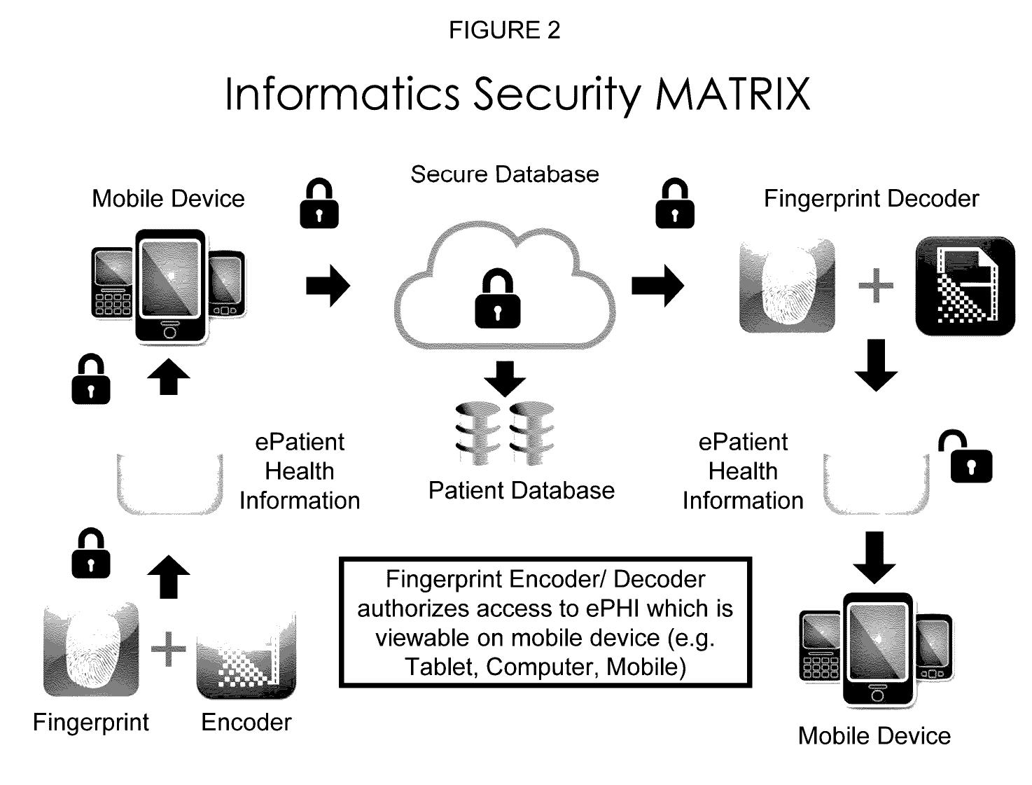

FIG. 2. illustrates one embodiment of a method of information security. The biometric identification of a patient's unique physiological feature (e.g. fingerprint, retina scan, facial recognition, RFID microchip) coupled with the encoder to secure patient information. Patient information is secured by only transmitting the patient's encrypted biometric identity, not the actual patient health record. The biometric identity is linked to only one patient profile (electronic patient health record). The biometric identity can then be transmitted via direct connection or wirelessly to a mobile device or mobile app, and stored in a secure cloud-based database. The decoder recognizes the distinct encrypted biometric identity, and must be used to access to the patients health record. The proprietary encoder and hardware that can process the securely encrypted information, coupled with B.I.T.S will authorize access to patient health information.

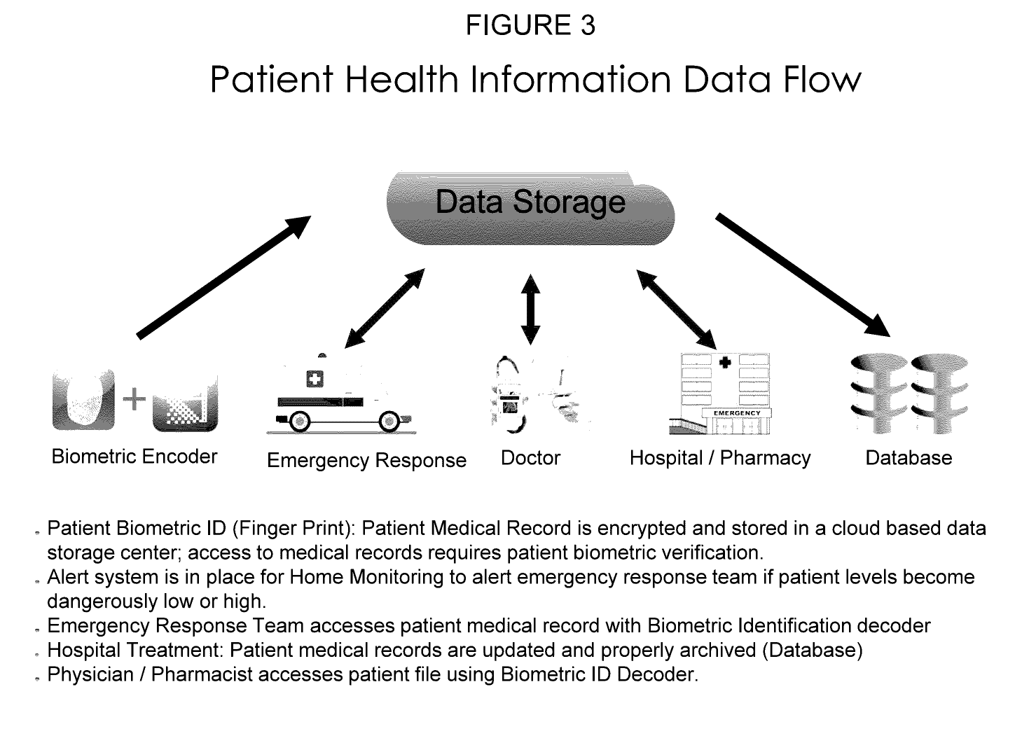

FIG. 3. illustrates the data flow in a useful application of the B.I.T.S platform. Patient biometric ID (finger print, retina scan, or RFID microchip scan): Patient Biometric ID is encrypted via encoder in which this data is and stored in a cloud-based data storage centers or secure servers. Access to medical records requires patient biometric verification and authorization. One feature in place for home monitoring application is an alert system that sends an SOS signal or alert to an emergency response team if patient vitals (e.g. blood sugar, heart rate, blood oxygenation) become dangerously low or high, presenting a life threatening acute health emergency. The emergency response team will have biometric ID decoders to access patient medical records. This will allow for the team to investigate prior health conditions, current medication use, medical allergies, and other valuable health indicators to assist with emergency response efforts. Once a patient is admitted to a hospital, patient medical records can be updated and properly archived using the biometric encoder and biometric decoder for authorization and access. All updated information is stored in the secure cloud-based or secure server(s) storage database for physicians across the globe to access patient health information for specialist consult or sharing of information amongst different hospitals, clinics, or medical networks. The patient data flow is also applicable to pharmacy networks allowing pharmacists to understand patient health conditions, current prescriptions, and ensure accurate prescriptions are administered to help eliminate the risk of adverse pharmaceutical drug reactions.

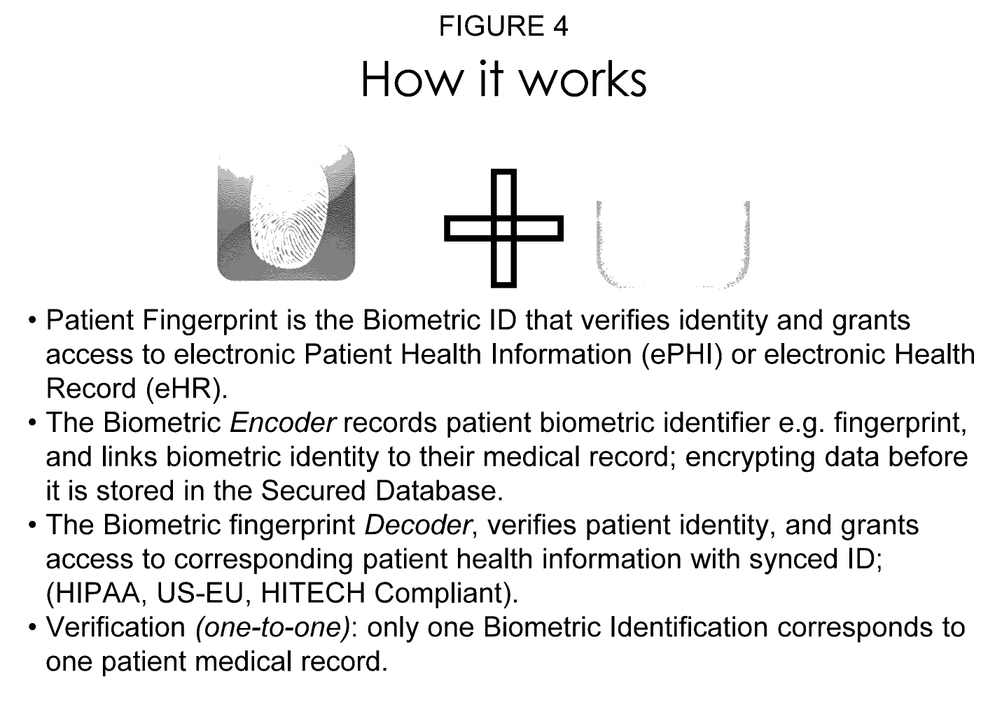

FIG. 4. illustrates the biometric security for one embodiment of the invention. The biometric ID (included in this embodiment is the fingerprint) verifies identity and grants access to electronic patient health information (ePHI) The biometric encoder records and encrypts patient biometric ID, and links biometric identity to one patient profile; encrypting data before it is stored in the cloud-based or secure server(s) database. The biometric decoder, verifies patient identity, and authorizes accesses to the corresponding patient health information with synced biometric ID; (HIPAA, US-EU, HITECH Compliant). Verification (one-to-one): only one biometric ID can be linked to one patient profile.

What is claimed is:

1. A method for encoding patient information for secure electronic transfer comprises:
obtaining patient identification information;
obtaining patient biometric identification information;
using the patient biometric identification information to create a distinct encrypted biometric identity; and
conditioning access to a patient's information on a match to the patient biometric identification.

2. A system for encoding patient information for secure electronic transfer comprises:
means for obtaining patient identification information;
means for obtaining patient biometric identification information;
an encoder to create a distinct encrypted biometric identity from the patient biometric identification information; and
means for conditioning access to a patient's information on a match to the patient's biometric identification.

3. A method for accessing patient information for secure electronic transfer comprises:
entering patient identification information;
entering patient biometric identification information; and
obtaining access to patient information based upon a match to the patient biometric identification information.

4. A method for secure electronic transfer of patient information comprises:
obtaining patient identification information;
obtaining patient biometric identification information;
using the patient biometric identification information to create and store a distinct encrypted biometric identity;
conditioning access to a patient's information on a match to a patient's biometric identification; and
entering patient biometric identification information to obtain access to patient information.
